(19) United States
(12) Patent Application Publication
(10) Pub. No.: US 2008/0240347 A1
(43) Pub. Date: Oct. 2, 2008

(54) METHOD, APPARATUS, AND SYSTEM FOR EXTENDING DEPTH OF FIELD (DOF) IN A SHORT-WAVELENGTH MICROSCOPE USING WAVEFRONT ENCODING

(75) Inventor: Scott H. Bloom, Encinitas, CA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: JMAR RESEARCH, INC., San Diego, CA (US)

(21) Appl. No.: 11/459,605

(22) Filed: Jul. 24, 2006

Related U.S. Application Data
(63) Continuation-in-part of application No. 11/161,880, filed on Aug. 19, 2005.
(60) Provisional application No. 60/701,842, filed on Jul. 22, 2005.

(51) Int. Cl. G21K 7/00

(52) U.S. Cl. 378/43

(57) ABSTRACT

A lens assembly for enhancing the depth of field of a short-wavelength microscopic system is disclosed. The lens assembly includes an objective zone plate lens, an encoding lens, an imaging detector and a decoding component connected to the imaging detector. The objective zone plate lens is oriented to receive short-wavelength radiation that has passed through a sample in a microscopic system. The encoding lens is oriented to receive the short-wavelength radiation that has passed through the objective zone plate lens and encode the radiation to output an encoded short-wavelength radiation. The imaging detector is oriented to receive the encoded short-wavelength radiation and convert it to a digital signal which is subsequently decoded by the decoding component to decode the encoding applied to the short-wavelength radiation.

### CROSS-REFERENCE TO RELATED APPLICATIONS

This application claims the benefit of U.S. Provisional Application No. 60/701,842 filed Jul. 22, 2005. Additionally, this application is a continuation-in-part of prior application Ser. No. 11/161,880 filed Aug. 19, 2005 entitled “Method and Apparatus for Enhanced Depth of Field in X-Ray Microscopy Using Objective Zone Plate Obscuration.” The disclosure of each of the above-identified applications is incorporated herein by reference.

### BACKGROUND

I. Field of the Invention

The embodiments disclosed in this application generally relate to using a wavefront encoding apparatus to increase the depth of field in a short-wavelength microscope.

II. Background of the Invention

Microscopy and tomography of biological and other materials based upon short-wavelength radiation (i.e., soft x-rays, etc.) is a growing area of interest. There are currently, for example, a handful of soft x-ray microscopes available to researchers for biological work. Unfortunately they each are required to be located at a synchrotron facility. Obviously there are several disadvantages to this over a tabletop system. Researchers must schedule work well in advance, which precludes near real time research. Also, traveling to a synchrotron facility requires expense and time in travel and setup that decreases a researcher's productivity. Finally, since the facilities are shared, projects are ranked and reviewed, a process that can stifle some of the most innovative projects. In contrast a user owned x-ray microscope permits rapid turn around, high productivity, and the ability to run numerous experiments, even those that might be considered too high risk for a national facility.

When imaging samples using a short-wavelength microscope, both the lateral resolution and the depth of field of the microscope are important. For example, typical samples for soft x-ray microscopes are on the order of about 8 microns in diameter. Accordingly, to accurately image the sample through its entire depth, a depth of field of about 4 μm is required. The depth of field of a microscope is inversely related to the numerical aperture of the objective lens. Thus, for high power objective lenses, the numerical aperture will be much greater and the depth of field will generally be much smaller, which may lead to an insufficient depth of field. Conversely, if the depth of field is expanded in a short-wavelength microscope, too much of its magnification power or numerical aperture may be sacrificed.

Typically optical designers make extended depth of focus systems by stepping down the aperture until the desired depth of focus is realized. The two primary issues with doing this is that less light is collected by the objective lens (by the square of the diameter) and the resolution of the optical system is decreased due to low pass spatial filtering. Current short-wavelength objective zone plates (i.e., objective lens) are being manufactured with outer zone widths of as small as about 15 nm. As the outer zone width decreases the resolution of the short-wavelength microscope increases (linearly), however the depth of focus of the microscope decreases (by the square) of the outer zone width making high resolution single cell soft x-ray tomography (the real advantage of an short-wavelength microscope) very difficult if not impossible.

### SUMMARY

Apparatuses, methods, and systems for a short-wavelength microscope that can effectively expand its depth of field without sacrificing too much of its magnification power or numerical aperture are disclosed.

In one aspect, a lens assembly for enhancing the depth of field of a short-wavelength microscopic system is disclosed. The lens assembly includes an objective zone plate lens, an encoding lens, an imaging detector and a decoding component connected to the imaging detector. The objective zone plate lens is oriented to receive short-wavelength radiation that has passed through a sample in a microscopic system. The encoding lens is oriented to receive the short-wavelength radiation that has passed through the objective zone plate lens and encode the radiation to output an encoded short-wavelength radiation. The imaging detector is oriented to receive the encoded short-wavelength radiation and convert it to a digital signal which is subsequently decoded by the decoding component. The decoding applied by the decoding component effectively decodes the encoding applied to the short-wavelength radiation.

In another aspect, a short-wavelength microscopic device includes a laser device, a target, a condenser zone plate, a sample stage, an objective zone plate, an encoding lens, and an imaging detector connected to a decoding component. The laser device is configured to emit laser pulses which are received by the target. The target converts the laser pulses into short-wavelength radiation that is received by the condenser zone plate configured to form a diffraction pattern having a focal spot at where the sample stage is positioned. The sample stage is configured to mount a specimen sample. The objective zone plate is operable to receive the short-wavelength radiation that has passed through the specimen sample. As the encoding lens receives the short-wavelength radiation, it encodes the radiation to output an encoded short-wavelength radiation received by the imaging detector. The imaging detector is configured to convert the encoded short-wavelength radiation to a digital signal which is then decoded by the decoding component.

In still another aspect, a method for increasing the depth field in a short-wavelength microscopic device is disclosed, wherein the device includes: a condenser zone plate that is operable to receive short-wavelength radiation and form a diffraction pattern having a first order focal spot, a sample stage that can mount a specimen sample and can be operable to be positioned at the first order focal spot, and an objective zone plate lens operable to receive short-wavelength radiation that has passed through the specimen sample and focus the radiation onto an encoding element. The encoding element is configured to encode the short-wavelength radiation to output an encoded short-wavelength radiation. An imaging detector is positioned to receive the encoded short-wavelength radiation. The imaging detector transforms the encoded short-wavelength radiation into a digital signal. The digital signal is sent to the a decoding component. The decoding component reverses the encoding applied to the short-wavelength radiation.

These and other features, aspects, and embodiments of the invention are described below in the section entitled “Detailed Description.”

### BRIEF DESCRIPTION OF THE DRAWINGS

For a more complete understanding of the principles disclosure herein, and the advantages thereof, reference is now made to the following descriptions taken in conjunction with the accompanying drawings, in which:

FIG. 1 is a block diagram depicting one embodiment of an improved short-wavelength microscope device including an objective zone plate lens with central zone obscuration;

FIG. 2 is another view of one embodiment of an improved short-wavelength microscope device including an objective zone plate lens with central zone obscuration;

FIGS. 3A-3C are graphs depicting the modular transfer function of various short-wavelength microscope systems with monochromatic illumination, illumination with 0.5% spectral bandwidth, and central obscuration of the objective zone plate lens, respectively; and

FIG. 4 is a graph depicting the point spread functions for a short-wavelength microscope system with central obscuration and without central obscuration, respectively.

FIG. 5 is an illustration of an improved short-wavelength microscope system including a short-wavelength encoding element and a decoding device, in accordance with one embodiment.

FIG. 6A is a ray diagram depicting traditional lens focusing of parallel short-wavelength radiation.

FIG. 6B is a ray diagram depicting what happens to the short-wavelength radiation when modified with a short-wavelength encoding element such as a cubic phase plate lens.

### DETAILED DESCRIPTION

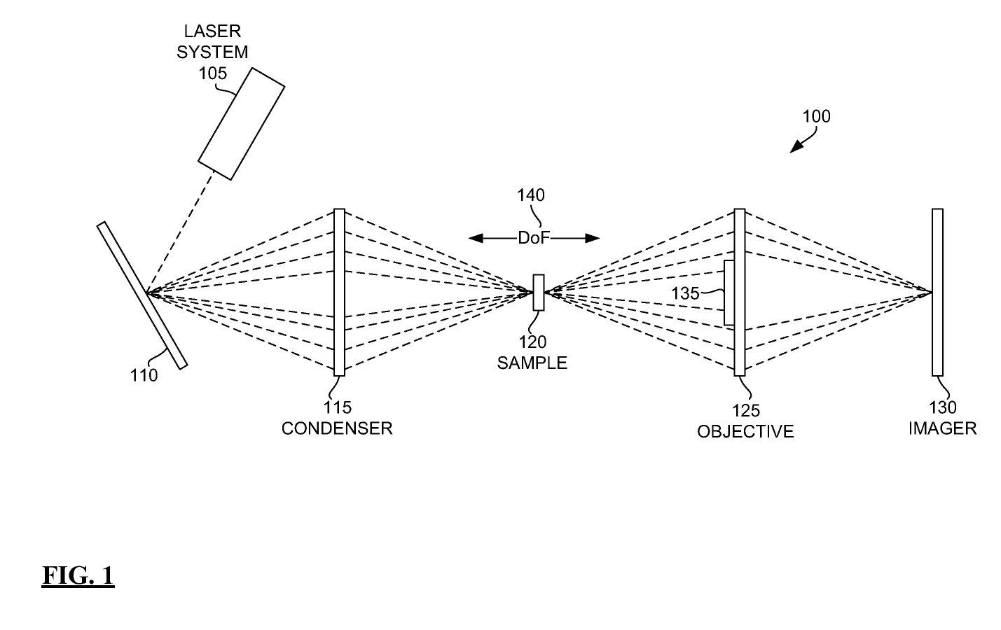

An exemplary system for enhancing the depth of field in a short-wavelength microscope system 100 is depicted in FIG. 1. In FIG. 1, a laser system 105 provides short pulse, high power, laser pulses that illuminate a target system 110. The target system 110 can comprise a metal tape system that is fed from one reel to another. When illuminated with a short pulse, high power, laser pulse, the illumination spot on the target forms a plasma that emits short-wavelength radiation, including X-rays. Suitable materials for the target tape system include copper, tin, or other materials that have a high conversion efficiency from laser energy to short-wavelength radiation. The short-wavelength radiation emitted by the illuminated target can be in the range of between about 0.5 nanometers (nm) to about 160 nm. Examples of laser systems suitable for use with the disclosed embodiment include the BriteLight™ laser available from JMAR Technologies, Inc. of San Diego, Calif., and laser systems described in U.S. Pat. Nos. 5,434,875; 5,491,707; and 5,790,574, all of which are hereby incorporated by reference into this description. Further examples of X-ray sources suitable for use in this system are described in U.S. Pat. Nos. 5,089,711 and 5,539,764, which are both hereby incorporated by reference into this description. Various other laser systems 105 and targets 110 suitable for use in this system are also described in the commonly owned U.S. patent application Ser. No. 10/907,321 entitled “Morphology and Spectroscopy of Nanoscale Regions Using X-rays Generated by Laser Produced Plasma,” which is hereby incorporated by reference into this application.

A condenser zone plate 115 captures some of the X-rays (or short-wavelength radiation) emitted by the target 110 and focuses those X-rays onto a focal spot, preferably on a sample stage 120. After the X-rays pass through the sample 120, they are captured by an objective lens 125, which preferably comprises another zone plate lens. It will be understood, however, that other types of lenses can be used depending on the requirements of the particular embodiment. After passing through the objective zone plate lens 125, the X-rays are passed to an imaging device 130, such as a CCD array.

The microscope system 100 has a depth of field 140, which is the zone of acceptable resolution of the imaged sample. The sample stage 120 can be moved between the condenser 115 and the objective 125 to align the specimen with the focal spot of the condenser zone plate lens 115. The depth of field 140 is determined by a variety of factors, including the wavelength of the illumination, the index of refraction of the medium surrounding the sample, the numerical aperture of the condenser and objective lenses (115, 125), and the magnification power of the objective lens 225. For many applications, it is desirable for the depth of field to be as large as possible, so that a larger range of features in the sample can be resolved in one image. As mentioned previously, however, the depth of field of high power objective lenses is very limited.

It has been discovered that obscuring one or more of the inner rings of the objective zone plate lens 125 will increase the depth of field 140 of microscope system 100. For example, an opaque plate 135 can be placed adjacent to the objective zone plate lens 125 so that one or more of the innermost rings of the objective zone plate array 125 are obscured. Another technique for obscuring the innermost rings in the objective zone plate lens 125 is to form the obscuring layer 135 directly on the objective zone plate 125 itself. This can be done by affixing an opaque plate 135 directly onto a pre-existing zone plate 125, or by fabricating a zone plate with one or more of the innermost rings being opaque rather than transparent. By obscuring the innermost rings of the objective zone plate lens 125, the image formed on the imager 130 will be formed only by the X-rays diffracted by the outer rings of the objective zone plate lens 125.

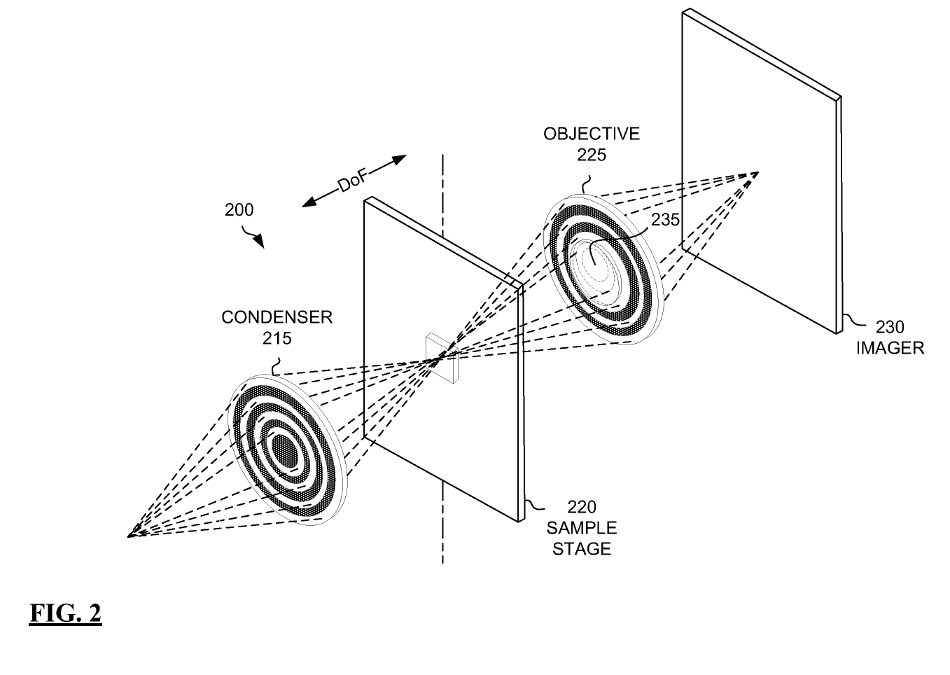

An alternative view of a microscope system 200 consistent with these principles is depicted in FIG. 2. In FIG. 2, a condenser zone plate lens 215 focuses short-wavelength radiation onto a sample stage 220. After passing through the sample stage, the X-rays are captured by an objective zone plate lens 225, which focuses the X-rays onto an imaging device 230. An opaque plate 235 can be placed adjacent to the objective zone plate lens 225 so that the innermost rings of the objective zone plate lens 225 are obscured so that no short-wavelength radiation passes through them. The opaque plate 235 can be either a separate plate that is placed in close proximity to the objective zone plate lens 235, or formed in the objective zone plate lens 235 itself. According to one embodiment of the disclosed invention, the opaque plate 235 for obscuring the inner zones of the objective zone plate lens 225 will cover about 50% of the diameter of the objective zone plate lens 225. Thus, for an objective zone plate lens 225 adapted for focusing short-wavelength radiation and having a first zone radius of about 1.2 μm, the opaque plate or opaque region will have a radius of about 9 μm. Suitable materials for the opaque plate 235 include any material that significantly restricts the passage of short-wavelength radiation, such as gold, lead, or any other malleable metal having a high atomic number.

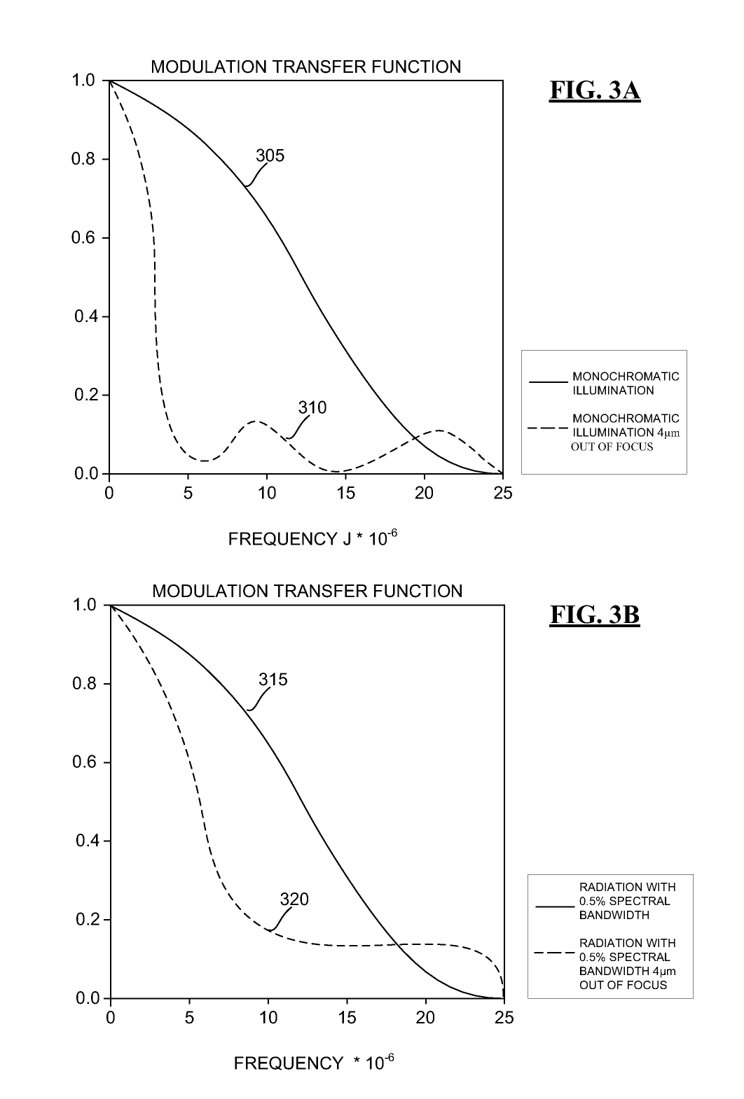

The effects of the obscuring the innermost rings of an objective zone plate lens in a short-wavelength microscope are depicted in FIGS. 3A-3C. FIG. 3A is a chart depicting the modulation transfer functions of a short-wavelength microscope system in which the inner rings of the objective zone plate have not been obscured. In FIG. 3A, the modulation transfer function (MTF) curve for an in-focus short-wavelength microscope with monochromatic illumination is depicted as curve 305. As can be seen in curve 305, the MTF is a smooth, bell-shaped decline as the frequency of the illumination source is moved from 1×10-6 to 25×10-6 Hz. The MTF curve 310 of an out-of-focus short-wavelength microscope with a monochromatic illumination is depicted in FIG. 3A. The MTF curve 310 corresponds to system in which the sample is 4 μm out of focus. Unlike the in-focus system, the MTF curve for the out-of-focus system 310 drops sharply from 1 to 0 as the frequency of the illumination is moved from 1×10-6 to 6×10-6. In addition, the MTF curve for the out-of-focus system 310 has zeros or near-zeros at about 6×10-6 and about 15×10-6, thus eliminating any effective resolution at those frequencies. Further, the large distance between curve 305 and curve 310 in FIG. 3A means that this microscope system quickly loses its resolution as it the sample is moved out of focus, meaning that it has a relatively small depth of field.

FIG. 3B is a chart depicting the modulation transfer functions of a short-wavelength microscope in which the inner rings of the objective zone plate are not obscured, but in which the illumination has a 0.5% spectral bandwidth instead of being monochromatic. The MTF curve 315 corresponds to an in-focus microscope system having 0.5% spectral bandwidth illumination. The MTF curve 320 corresponds to the same system, but in which the microscope system is 4 μm out-of-focus. As can be seen in FIG. 3B, the MTF curve of the in-focus system (315) slopes gently down from one to zero as the frequency of illumination is moved from 1×10-6 to 25×10-6. It can also be seen that the MTF curve of the out-of-focus system 320 includes no significant roots or poles, thereby making it a smoother curve than the MTF curve for the monochromatic system 310. Further, the MTF curve of the out-of-focus system 320 is much closer to the MTF curve of the in-focus system 315, meaning that the depth of field of the microscope system with 0.5% spectral bandwidth illumination is greater than the microscope system with monochromatic illumination.

FIG. 3C is a chart depicting the modulation transfer functions of a short-wavelength microscope system in which the inner rings of the objective zone plate are obscured and in which the short-wavelength radiation illumination has a 0.5% spectral bandwidth. The MTF curve of an in-focus sample with central obscuration is depicted as curve 325. Similarly, the MTF curve of a sample that is 4 μm out-of-focus with central obscuration is depicted as curve 330. The MTF curve of the in-focus system 325 slopes down from one to zero as the frequency of the illumination is moved from 1×10-6 to 25×10-6. When compared to the in-focus MTF curve 315 of FIG. 3B, it can be seen that MTF curve with central obscuration 325 is less linear than a microscope system without central obscuration (curve 315). Further, the out-of-focus MTF curve with 0.5% spectral bandwidth and central obscuration 330 includes several roots and poles, but the out-of-focus curve 330 is much closer to the in-focus curve 325. This means that the depth of field of the microscope system having a central obscuration plate is significantly greater than the microscope system without central obscuration. A greater depth of field is particularly desirable for applications such as tomography with a soft X-ray microscope.

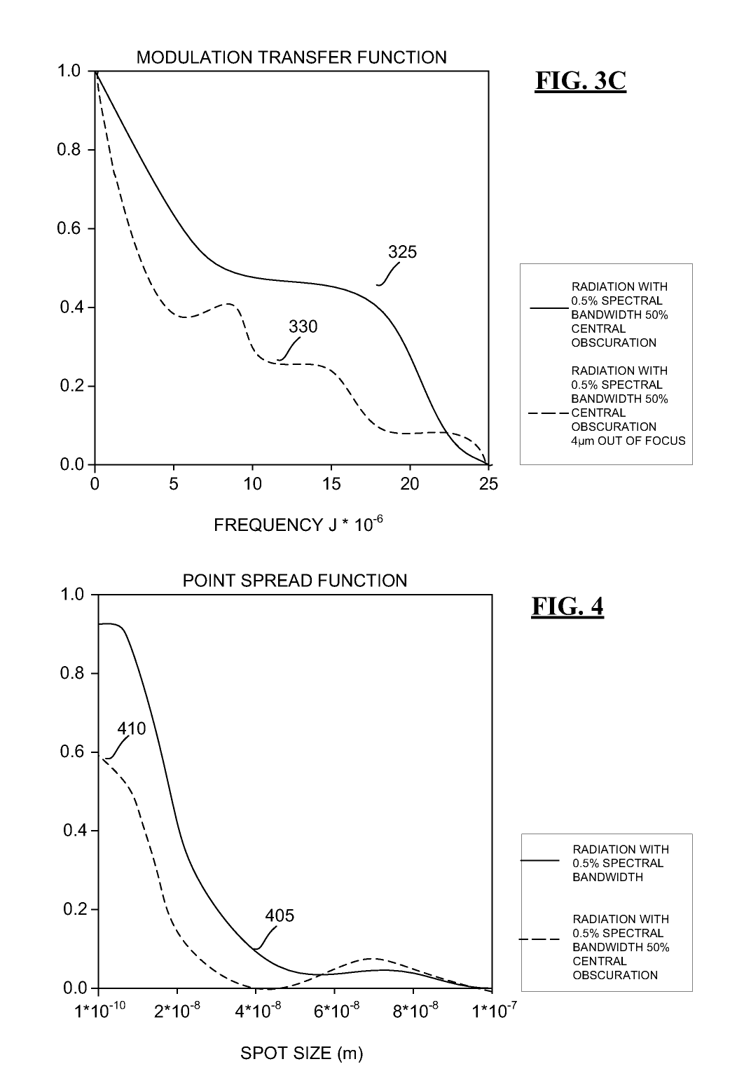

FIG. 4 is a chart depicting the point spread functions of an X-ray microscope system in which the inner rings of the objective zone plate are obscured and in which the short-wavelength radiation illumination has a 0.5% spectral bandwidth. Curve 405 corresponds to the point spread function for a short-wavelength microscope system having illumination with 0.5% spectral bandwidth but lacking central obscuration. Curve 410 corresponds to the point spread function for a short-wavelength microscope system having illumination with 0.5% spectral bandwidth and including central obscuration of the objective zone plate. FIG. 4 demonstrates that although the intensity of the PSF curve without central obscuration 405 is significantly less than the intensity of the PSF curve without central obscuration 415, the relative shapes of these curves is very similar. Accordingly, obscuring the central zones of the objective zone plate in a short-wavelength microscope will reduce the intensity of the imaged sample, but will not significantly detract from the lateral image quality.

In another embodiment, the tomographic capability (i.e., depth of field) can be extended and the imaging time for a short-wavelength microscope can be reduced by using wavefront encoding in the short-wavelength (i.e., soft x-ray regime). Wavefront encoding is a term used to describe the insertion of a special phase plate near the objective lens that extends the depth of focus of the optical imaging system by as much as a factor of 10 over a conventional imaging system. This can permit an increase in achievable resolution by a factor of three, yet retain the capability of short-wavelength tomography on, e.g., whole cells. In addition, enhanced depth of focus should relax the requirement that the illumination spectral bandwidth match the number of zones in the objective zone plate since the enhanced depth of focus allows a broadening of the radiation by the same eight to ten factor.

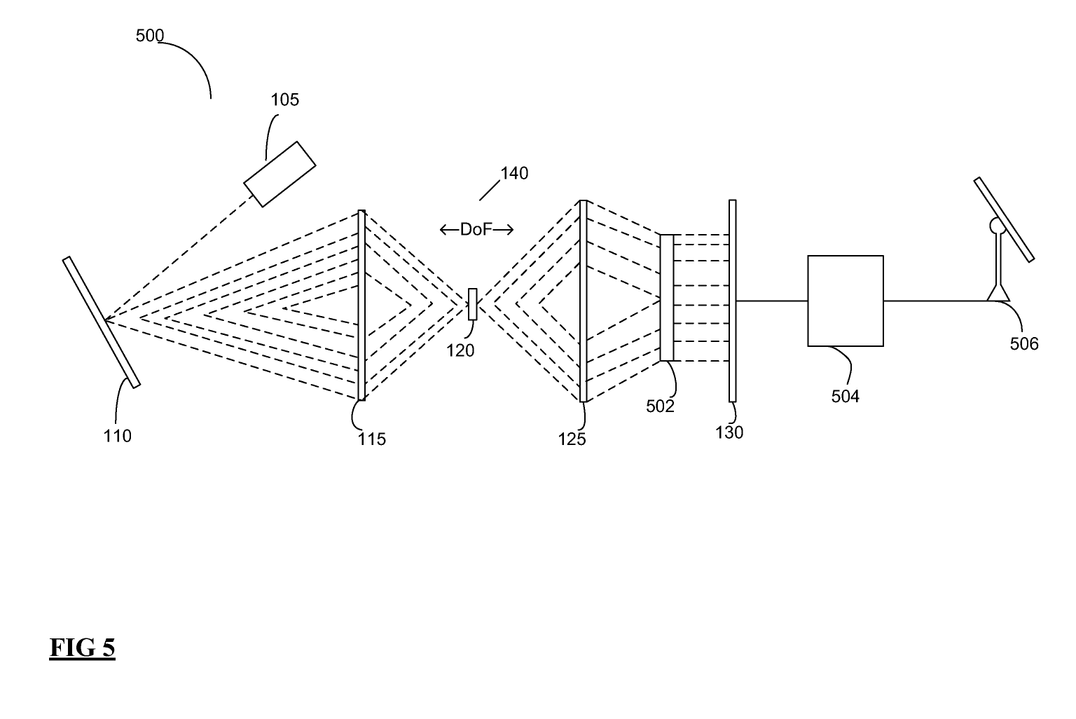

FIG. 5 is an illustration of a short-wavelength microscope system including a short-wavelength encoding element and a decoding device, in accordance with one embodiment of the present invention. As depicted in this embodiment, the microscope system 500 includes a laser system 105 that provides short pulse, high power, laser pulses that illuminates a target 110. As discussed previously, the target 110 is configured to convert the laser pulse into short-wavelength radiation by forming a plasma that emits short-wavelength radiation. In one embodiment, target 110 is configured to emit short-wavelength radiation in the range of between about 0.5 nanometers (nm) to about 160 nm. In another embodiment, the target 110 is configured to emit short-wavelength radiation in the “water window” wavelength range of between about 2.3 nanometers (nm) and about 4.4 nm.

The short-wavelength radiation is directed at a condenser zone plate 115 which is positioned to capture the radiation and focus them onto a focal spot, which in this embodiment is the sample stage 120. After the short-wave radiation passes through the sample 120, it is captured by an objective lens 125. In one embodiment, the objective lens 125 is a zone plate type lens such as a Fresnel zone plate. It should be appreciated that the objective lens 125 can essentially be any type of lens as long as the objective lens 125 can be configured to optimally focus the short-wave radiation towards an intended target.

Continuing with FIG. 5, the distance in front of the condenser zone plate 115 and behind the objective lens 125 where the sample stage 120 needs to be positioned to remain in focus is termed the depth of field 140 for the microscopic system 500. As discussed previously, it is desirable for the depth of field 140 to be as large as possible so that a larger range of features in a sample can be resolved into one single image. One method to significantly increase the depth of field 140 for the system 500, is to couple wavefront coding imaging components (i.e., encoding element 502 and decoding component 504) with the other optical elements of the microscope system 500. An ancillary benefit to increasing the depth of field 140 for the system 500 is that it will also correct for chromatic aberrations that occur in the system 500 by increasing the depth of field 140 for each wavelength of the short-wavelength radiation that makes up the sample image. As used herein, chromatic aberrations occur when the different wavelengths of light are focused at different points on a focal plane as they pass through a lens (e.g., objective lens 125, etc.).

The basic principle behind wavefront coding imaging is to uniformly encode (i.e., blur) the short-wavelength radiation conveying the sample image from all planes to desensitize the image to depth of field 140 distortions (i.e., focus), capturing the image onto a digital imager designed for capturing the encoded radiation and converting the image to a digital signal, and decoding the digital signal to remove the effects (i.e., blurring) of the original encoding.

As depicted herein FIG. 5, the wavefront coding components (i.e., encoding element 502 and decoding component 504) are added to process the short-wavelength radiation after it has passed through the objective lens 125. The encoding element 502 is configured to capture all the short-wavelength radiation that has passed through the objective lens 125 and encodes (i.e., alter) the radiation in accordance with the chosen type of encoding technique for the particular application.

In one embodiment, the encoding element 502 is a cubic phase plate lens that (i.e., encoding element 502) effectuates a phase shift encoding technique. The cubic phase plate lens should be manufactured on a thin x-ray transmissive membrane such as silicon nitride. The, e.g., nickel coating should be very thin, on the order of about 100 nanometers (nm) and should be processed to have a cubic functional form. The processing can be performed using standard lithographic techniques, possibly using an ion beam milling machine to impose the cubic functional form on the surface of the nickel. A surface profiling instrument, such as an Atomic Force Microscopy (AFM) instrument, can be used to make sure the nickel has the required shape. Examples of other suitable materials that the cubic phase plate lens can be fabricated from includes polymer-based substrates and zinc sulfide. However, it should be appreciated that the cubic phase plate lens can essentially be made out of any material as long as the lens can effectively encode short-wavelength radiation in accordance with the particular encoding technique being used.

The cubic phase plate (i.e., encoding element 502) phase shifts the short-wavelength radiation in accordance to an algorithmic step function. It should be understood that essentially any type of encoding element 504 and corresponding encoding technique can be employed to alter the short-wavelength radiation as long as the image conveyed by the short-wavelength radiation is “blurred” to produce an encoded image that is nearly independent of focus and the encoding technique can be later reversed by a decoding component 504.

Still with FIG. 5, after being encoded by the encoding element 502, the encoded short-wavelength radiation is directed towards an imaging detector 130 that is positioned to substantially capture all the encoded radiation. The imaging detector 130 is configure to detect and convert the encoded radiation into a digital signal. In one embodiment, the imaging detector 130 is a charged-coupled device (CCD) array. In another embodiment, the imaging detector 130 is an active pixel sensor array. It should be appreciated that essentially any type of imaging detector 130 can be used as long as the detector 130 can be used to substantially capture all the encoded short-wavelength radiation that passes through the encoding element 502 and convert the radiation to a digital signal without introducing an unacceptable amount of image noise or substantially decreasing the quality of the image.

After the encoded radiation is converted into a digital signal by the imaging detector 130, the signal is communicated to a decoding component 504 that is configured to reverse the encoding applied to the original non-encoded short-wavelength radiation. In one embodiment, decoding component 504 is a microprocessor or equivalent device that is configured to apply a logical algorithm (mathematical or otherwise) to the digital signal to reverse the encoding (i.e., decode the digital signal). In another embodiment, the decoding component 504 is a circuit that is configured to apply a logical algorithm to the digital signal to reverse the encoding. Following the decoding of the digital signal by the decoding component 504, the digital signal can be displayed on a high resolution display 506 such as a liquid crystal display (LCD) or equivalent device.

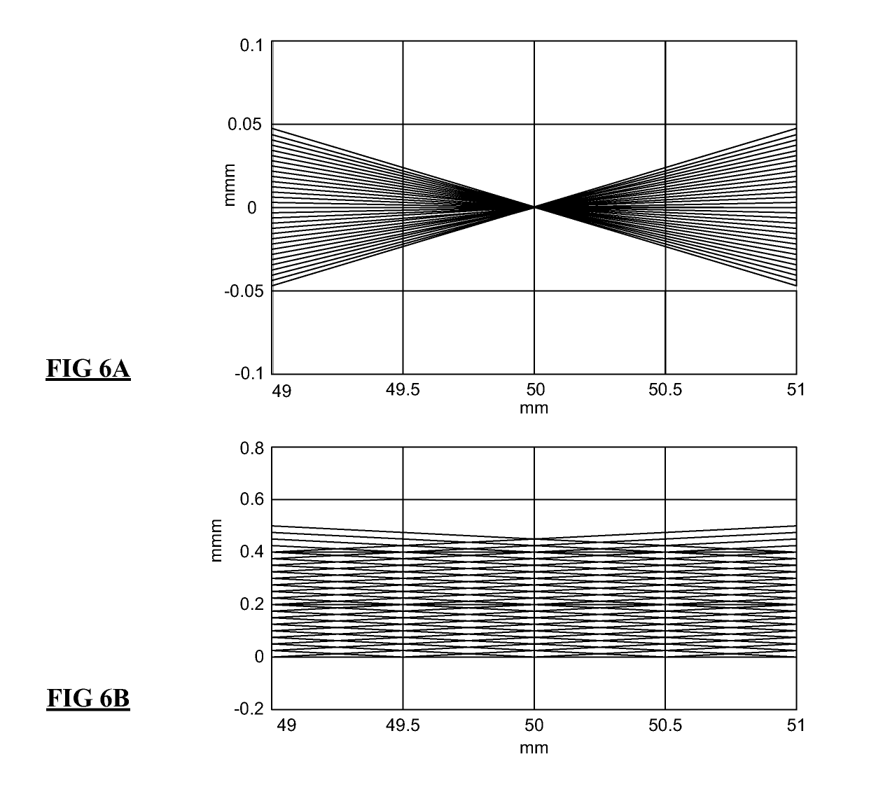

FIG. 6A is a ray diagram depicting traditional lens focusing of parallel short-wavelength radiation. The vertical axis represents ray height. As can be clearly discerned in this illustration, the rays all converge to a focal point at the optical axis (or horizontal axis) in the ray diagram. That focal point at 50 millimeters (mm) represents the point of best focus. As you move the image plane (or the sample) nearer or farther away from the focal point, the quality (e.g., sharpness, etc.) of the image decreases as depicted by the decreasing ray density shown in the diagram.

FIG. 6B is a ray diagram depicting what happens to the short-wavelength radiation when modified with an encoding element such as a cubic phase plate lens. The vertical axis represents ray height. As depicted, the rays no longer travel towards a point of best focus but instead remains substantially the same all throughout the optical axis. This means that the light rays from the encoding element no longer travels toward a point of best focus but instead travels so that the distribution of the rays is very insensitive to the position of the image plane. That is, the ray density is very insensitive to the position of the image plane. All the rays of the image are uniformly out of focus or blurred. When a decoding function is uniformly applied to the rays, the ray density of the resulting image will be uniformly dense across the entire optical axis.

Although a few embodiments of the present invention have been described in detail herein, it should be understood, by those of ordinary skill, that the present invention may be embodied in many other specific forms without departing from the spirit or scope of the invention. Therefore, the present examples and embodiments are to be considered as illustrative and not restrictive, and the invention is not to be limited to the details provided therein, but may be modified and practiced within the scope of the appended claims.

What is claimed is:

1. A lens assembly for enhancing the depth of field of a short-wavelength microscopic system, comprising:
an objective zone plate lens oriented to receive short-wavelength radiation that has passed through a sample in a microscopic system;
an encoding lens oriented to receive the short-wavelength radiation that has passed through the objective zone plate lens, the encoding lens configured to encode the short-wavelength radiation to output an encoded short-wavelength radiation;
an imaging detector oriented to receive the encoded short-wavelength radiation, the imaging detector configured to convert the encoded short-wavelength radiation to a digital signal; and
a decoding component connected to the imaging plate and configured to process the digital signal to decode the encoding applied to the short-wavelength radiation.

2. The lens assembly for enhancing the depth of field of a short-wavelength microscopic system, as recited in claim 1, wherein the encoding applied results in a phase shift of the short-wavelength radiation.

3. The lens assembly for enhancing the depth of field of a short-wavelength microscopic system, as recited in claim 2, wherein the decoding component applies an algorithm to the digital signal to reverse the phase shift applied to the short-wavelength radiation.

4. The lens assembly for enhancing the depth of field of a short-wavelength microscopic system, as recited in claim 1, wherein the imaging detector is one of a charged-coupled device (CCD) array or an active pixel sensor array.

5. The lens assembly for enhancing the depth of field of a short-wavelength microscopic system, as recited in claim 1, wherein the encoding lens is a cubic phase plate lens.

6. The lens assembly for enhancing the depth of field of a short-wavelength microscopic system, as recited in claim 5, wherein the cubic phase plate lens is fabricated from a material that is selected from a group consisting of a polymer-based substrate, a zinc sulfide substrate, and a nickel coated silicon nitride substrate.

7. A short-wavelength microscopic device, comprising:
a laser device configured to emit laser pulses;
a target positioned to receive the laser pulses and configured to convert the laser pulses into short-wavelength radiation;
a condenser zone plate operable to receive short-wavelength radiation and form a diffraction pattern having a focal spot;
a sample stage onto which a specimen sample can be mounted, wherein the sample stage is operable to be positioned at the focal spot;
an objective zone plate operable to receive the short-wavelength radiation that has passed through the specimen sample;
an encoding lens oriented to receive the short-wavelength radiation that has passed through the objective zone plate, the encoding lens configured to encode the short-wavelength radiation to output an encoded short-wavelength radiation;
an imaging detector oriented to receive the encoded short-wavelength radiation, the imaging detector configured to convert the encoded short-wavelength radiation to a digital signal; and
a decoding component connected to the imaging plate and configured to process the digital signal to decode the encoding applied to the short-wavelength radiation.

8. The short-wavelength microscopic device, as recited in claim 7, wherein the laser pulses have a wavelength of between about 2.3 nanometers (nm) and about 4.4 nm.

9. The short-wavelength microscopic device, as recited in claim 7, wherein the encoding applied results in a phase shift of the short-wavelength radiation.

10. The short-wavelength microscopic device, as recited in claim 8, wherein the decoding component applies an algorithm to the digital signal to reverse the phase shift applied to the short-wavelength radiation.

11. The short-wavelength microscopic device, as recited in claim 7, wherein the imaging detector is one of a charged-coupled device (CCD) array or an active pixel sensor array.

12. The short-wavelength microscopic device, as recited in claim 7, wherein the encoding lens is a cubic phase plate lens.

13. The short-wavelength microscopic device, as recited in claim 12, wherein the cubic phase plate lens is fabricated from a material that is selected from a group consisting of a polymer-based substrate, a zinc sulfide substrate, and a nickel coated silicon nitride substrate.

14. The short-wavelength microscopic device, as recited in claim 7, wherein the material used to fabricate the target is one of copper or tin.

15. A method for increasing the depth field in a short-wavelength microscopic device, comprising:
providing a short-wavelength microscope device, the microscope device including,
a condenser zone plate operable to receive short-wavelength radiation and form a diffraction pattern having a first order focal spot,
a sample stage onto which a specimen sample can be mounted, wherein the sample stage is operable to be positioned at the first order focal spot, and
an objective zone plate lens operable to receive short-wavelength radiation that has passed through the specimen sample and focus the short-wavelength radiation onto an encoding element, the encoding element configured to encode the short-wavelength radiation to output an encoded short-wavelength radiation;
positioning an imaging detector to receive the encoded short-wavelength radiation;
transforming the encoded short-wavelength radiation into a digital signal;
sending the digital signal to a decoding component; and
reversing the encoding applied to the short-wavelength radiation using the decoding component.

16. The method for increasing the depth field in a short-wavelength microscopic device, as recited in claim 15, wherein the encoding applied results in a phase shift of the short-wavelength radiation.

17. The method for increasing the depth field in a short-wavelength microscopic device, as recited in claim 16, wherein the decoding component applies an algorithm to the digital signal to reverse the phase shift applied to the short-wavelength radiation.

18. The method for increasing the depth field in a short-wavelength microscopic device, as recited in claim 15, wherein the imaging detector is one of a charged-coupled device (CCD) array or an active pixel sensor array.

19. The method for increasing the depth field in a short-wavelength microscopic device, as recited in claim 15, wherein the encoding element is a cubic phase plate lens.

20. The method for increasing the depth field in a short-wavelength microscopic device, as recited in claim 19, wherein the cubic phase plate lens is fabricated from a material that is selected from a group consisting of a polymer-based substrate, a zinc sulfide substrate, and a nickel coated silicon nitride substrate.
